(19) United States
(12) Patent Application Publication
(10) Pub. No.: US 2012/0135676 A1
(43) Pub. Date: May 31, 2012

(54) SYSTEM AND METHOD FOR DEPLOYMENT AND MANAGEMENT OF INTERACTIVE REGIONAL BROADCAST SERVICES

(75) Inventors: Cheng-Yu Wu, Hualien (TW); Channing Chang, Changhua (TW); Adam Feng, Hsinchu (TW)

(73) Assignee: INDUSTRIAL TECHNOLOGY RESEARCH INSTITUTE, Hsinchu (TW)

(21) Appl. No.: 12/954,728

(22) Filed: Nov. 26, 2010

(51) Int. Cl. H04H 20/71

(52) U.S. Cl. 455/3.01

(57) ABSTRACT

A system has a plurality of agents with each of a plurality of road side units (RSUs) having at least an agent of the plurality of agents being deployed to deploy and manage interactive regional broadcast services. Each agent includes a RSU receiving/transmitting device to receive at least a service deployment message and broadcast at least a service tracking request, and a storage device to maintain a service table recording at least a service that currently performs broadcasting service content on a corresponding RSU and a service-related topology table recording at least a RSU in a neighborhood of the corresponding RSU when an interactive regional service broadcasting being performed. A processor in the agent may perform interactive regional service deployment, interactive regional service termination and interactive regional service tracking, manage and accomplish at least a broadcast service through the corresponding RSU and the two tables.

### TECHNICAL FIELD

The disclosure generally relates to a system and method for deployment and management of interactive regional broadcast services.

### BACKGROUND

As the widespread of the global positioning system (GPS) and communication technology, the location-based service (LBS) becomes a new popular application technology. The LBS means the value-added location related services are provided based on the location of the mobile communication devices. The LBS may provide appropriate services according to the time and location of the mobile communication devices.

One prior art disclosed a scheme that may provide information in a cellular communication network, in which the user may share information or upload service through mobile devices. FIG. 1 shows an exemplary arrangement of a network architecture in which the scheme may be implemented. In FIG. 1, a public data network 10 is provided for offering data services. Data services may be provided with mobile devices via a mobile communication system. The communication system in FIG. 1 is typically arranged to serve a plurality of mobile communication devices. It may include, such as, mobile devices 11-12, base transceiver stations (BTSs) 21-24, and back-end servers. The back-end servers have the capability of satellite positioning analysis, the mobile devices 11-12 upload GPS positioning information and service content, and the back-end servers analyze the target location and the relative BTSs so that the BTSs may transfer information and service content to the specific mobile devices. Basically, the service broadcast mechanism of the scheme has a architecture of client-server, and the mobile devices are required to return the positioning information for the back-end server to select suitable BTSs to accomplish the task of information and service content broadcast.

Another prior art entitled WAVE design for next dedicated short range communication (DSRC) applications disclosed practical vehicle wireless communication systems for next new DSRC applications, in which WAVE evaluation systems have been installed into public transportation as on board units (OBUs). FIG. 2 shows an exemplary view of a WAVE field test system configuration. In FIG. 2, when a WAVE OBU 210 approaches to a communication area of a bus stop, inside video streaming of bus is transferring to a center server unit 220 via the bus stop and intersection as road side units (RSUs), such as WAVE RSU 1˜WAVEE RSU 3. The real time video streaming may be received from an intersection RSU via the bus stop. In IEEE802.11p specification, those streaming real time videos use WAVE service channel (SCH) for transmission. At the same time, a WAVE OBU sends a bus identifier to the center server unit 220 via the bus stop by a WAVE control channel (CCH), and bus location is indicated in a monitor screen of center server unit 220 on a bus stop map.

Many services are often real-time, ad hoc, and temporary, such as mobile economic entities. On the other hand, the conventional prior arts or studies on LBS are often concentrated on fixed locations or based on the client-server architecture that DSRC end needs to return the LBS information to the clients. Therefore, how to assist the mobile entities to rapidly deploy real-time, ad hoc and temporary LBS to inform the service subscribers of the existence of the available services is an imperative issue.

### SUMMARY

The exemplary embodiments may provide a system and method for deployment and management of interactive regional broadcast services.

One disclosed exemplary embodiment relates to a system for deployment and management of interactive regional broadcast services. The system comprises a plurality of agents with each of a plurality of road side units (RSUs) having at least an agent of the plurality of agents being deployed, and each agent further includes a RSU receiving/transmitting device for receiving at least a service deployment message and broadcasting at least a service tracking request; a storage device for maintaining a service table recording information of at least a service currently performing service content broadcasting on a corresponding RSU, and a service-related topology table recording information of at least a RSU in a neighborhood of the corresponding RSU that can connect to the corresponding RSU, when an interactive regional service broadcasting is performed; and a processor for performing interactive regional service deployment, interactive regional service termination and interactive regional service tracking, managing and accomplishing at least a broadcast service through the corresponding RSU and information recorded in the service table and the service-related topology table.

Another disclosed exemplary embodiment relates to a method for deployment and management of interactive regional broadcast services. The method comprises: preparing a plurality of agents with each of a plurality of road side units (RSUs) having at least an agent of the plurality of agents being deployed; each agent receiving at least a service deployment message and broadcasting at least a service tracking request, through a corresponding RSU for an associated agent of the plurality of agents; and providing a plurality of processors with each processor being in one of the plurality of agents for performing interactive regional service deployment, interactive regional service termination and interactive regional service tracking, managing and accomplishing at least a broadcast service through the plurality of RSUs.

Yet another disclosed exemplary embodiment relates to a road side unit (RSU) in a system for deployment and management of interactive regional broadcast services. The RSU comprises at least an agent configured to: receive at least a service deployment message transmitted by a service provider and broadcast at least a service tracking request transmitted by a service requester; and provide a processor for performing interactive regional service deployment, interactive regional service termination and interactive regional service tracking, managing and accomplishing at least a broadcast service.

The foregoing and other features, aspects and advantages of the present disclosure will become better understood from a careful reading of a detailed description provided herein below with appropriate reference to the accompanying drawings.

### BRIEF DESCRIPTION OF THE DRAWINGS

FIG. 1 shows an exemplary arrangement of a network architecture, in which the user may share information or upload service through mobile devices in a cellular communication network.

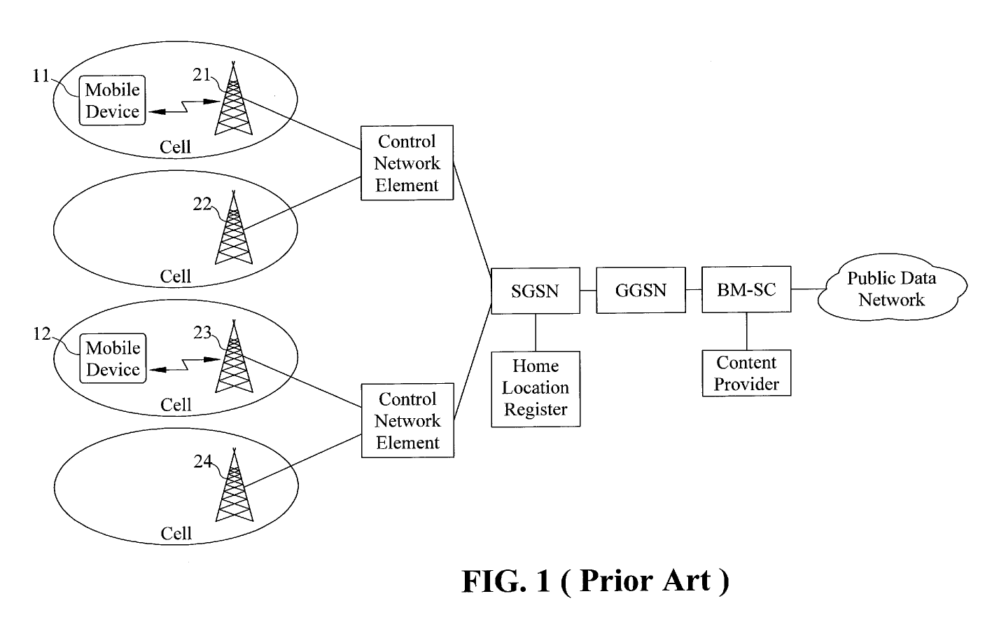

FIG. 2 shows an exemplary view of a WAVE field test system configuration.

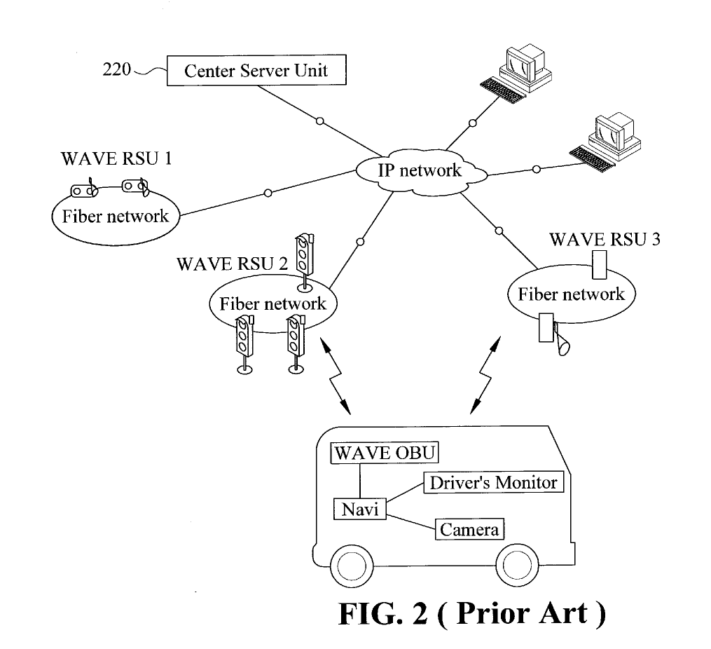

FIG. 3 shows an exemplary schematic view illustrating how a mobile service provider provides LBS services, consistent with certain disclosed embodiments.

FIG. 4 shows an exemplary system for deployment and management of interactive regional broadcast services, consistent with certain disclosed embodiments.

FIG. 5a shows an exemplary field format of service table and .FIG. 5b shows a working example of the table, consistent with certain disclosed embodiments.

FIG. 6a shows an exemplary field format of service-related topology table and FIG. 6b shows a working example of the table, consistent with certain disclosed embodiments.

FIG. 7 shows an exemplary service-related topology table of a source RSU 1 consistent with certain disclosed embodiments.

FIG. 8 shows an exemplary operation flow of a method for deployment and management of interactive regional broadcast services, consistent with certain disclosed embodiments.

FIG. 9 shows an exemplary schematic view illustrating the interactive regional service deployment among the service provider, the corresponding RSU and its neighboring RSUs, consistent with certain disclosed embodiments.

FIG. 10 shows an exemplary operation flow illustrating how an agent deployed in a corresponding RSU broadcasts the requested service deployment, consistent with certain disclosed embodiments.

FIG. 11 shows an exemplary schematic view illustrating the interactive regional service termination among the service provider, the corresponding RSU and its neighboring RSUs, consistent with certain disclosed embodiments.

FIG. 12 shows an exemplary schematic view illustrating the service termination initiated through a service provider's corresponding RSU, consistent with certain disclosed embodiments.

FIG. 13 shows an exemplary schematic view illustrating the service termination initiated by a service provider itself, consistent with certain disclosed embodiments.

FIG. 14 shows an exemplary schematic view illustrating the interactive regional service tracking, consistent with certain disclosed embodiments.

### DETAILED DESCRIPTION OF THE EXEMPLARY EMBODIMENTS

The exemplary embodiments of the present disclosure provide a mechanism for deployment and management of interactive regional broadcast services, and may assist the service provider to rapidly deploy the LBS. In the exemplary embodiments, interactive regional service deployment is utilized to perform the LBS deployment. For the termination and recycling of LBS, interactive regional service termination is performed and service time constrain is utilized. During the LBS service, the communication between a service user and a mobile service provider is accomplished by RSUs via interactive regional service tracking.

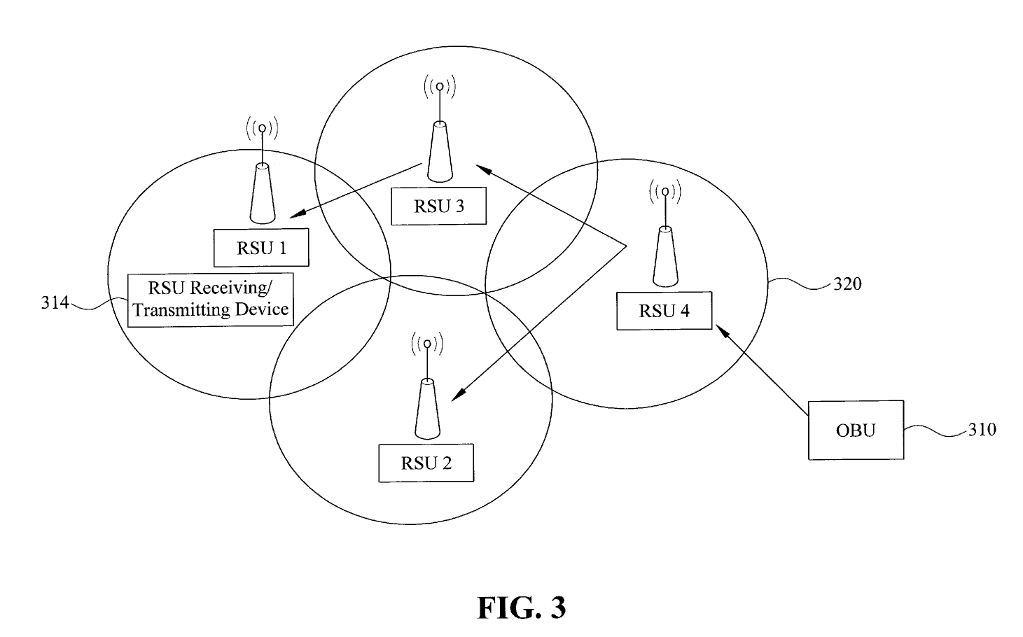

FIG. 3 shows an exemplary schematic view illustrating how a mobile service provider provides LBS services, consistent with certain disclosed embodiments. In the example of FIG. 3, a mobile service provider, such as OBU 310, only needs to transmit a LBS service deployment message 312 to be-broadcasted to one of the RSU, such as RSU 4, in the encompassing region 320 and selects a location range and a duration of time of the LBS service, an agent in the RSU 4 will broadcast the information to the selected region. Each agent in a corresponding RSU mayo manages and accomplishes broadcast services for its RSU, therefore, each agent needs to follow and maintain two relation tables referred as service-related topology table and service table, respectively. An agent may include a storage device to maintain the two relation tables. The agent may also include a RSU receiving/transmitting device, such as RSU receiving/transmitting device 314 in RSU1, to receive the transmitted LBS service deployment message at least including the information of a location range and a duration of time of the LBS service. The information may be selected by the mobile service provider when applying for the service broadcasting. A service requester may issue a service tracking request to a nearest RSU to obtain a service after the service requester obtains the service broadcast message within the coverage of the RSU. The service tracking request at least includes information of a service code and a service-related message.

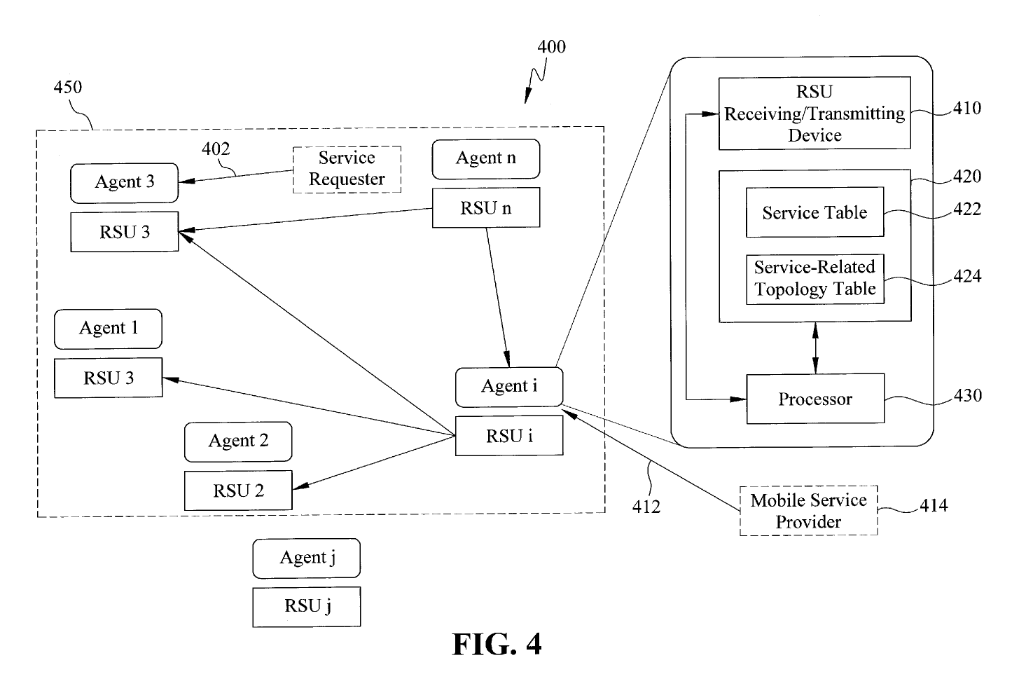

Accordingly, the agent may further include a processor to perform interactive regional service deployment, interactive regional service termination and interactive regional service tracking, as well as manage and accomplish broadcast services for the RSU. FIG. 4 shows an exemplary system for deployment and management of interactive regional broadcast services, consistent with certain disclosed embodiments.

Referring to FIG. 4, for a plurality of RSUs, such as RSU 1, RSU 2, . . . RSU n, system 400 may comprise n agents, such as agent 1, agent 2, . . . , agent n, each agent i is deployed in a corresponding RSU i, 1≦i≦n. The agent i may include a RSU receiving/transmitting device 410 to receive at least a service deployment message 412 from a mobile service provider 414, and broadcasting at least a service request 402 to other agents for further tracking. The information in the service deployment message 412 at least includes a location range and a duration of time to be broadcasted for a corresponding service. The location range and the time duration may be selected by the mobile service provider 414. The agent i may also include a storage device 420 to maintain relation tables referred as service table 422 and service-related topology table 424. Service table 422 may record the services that currently perform broadcasting service content on the RSU i. Service-related topology table 424 may record the service-related RSUs when the agent i performs the service broadcasting. The agent i may further include a processor 430 to perform interactive regional service deployment, interactive regional service termination and interactive regional service tracking, for managing and accomplishing broadcast services through the RSU and the two tables 422 and 424.

In the exemplary embodiment of FIG. 4, the at least a service request 402 may be from a service requester nearby a RSU such as RSU 3. One or more RSUs may be not the RSU in the RSUi's deployment coverage 450 that can connect to RSUi through traffic, after the processor 430 performs a regional service deployment for a service deployment request. For example, RSUj is not the RSU in the RSUi's deployment coverage 450 that can connect to RSUi through traffic, 1≦j≦n and j≠i. The following will describe in detail how processor 430 performs interactive regional service deployment, interactive regional service termination and interactive regional service tracking, for managing and accomplishing broadcast services through the RSU and the two tables 422 and 424.

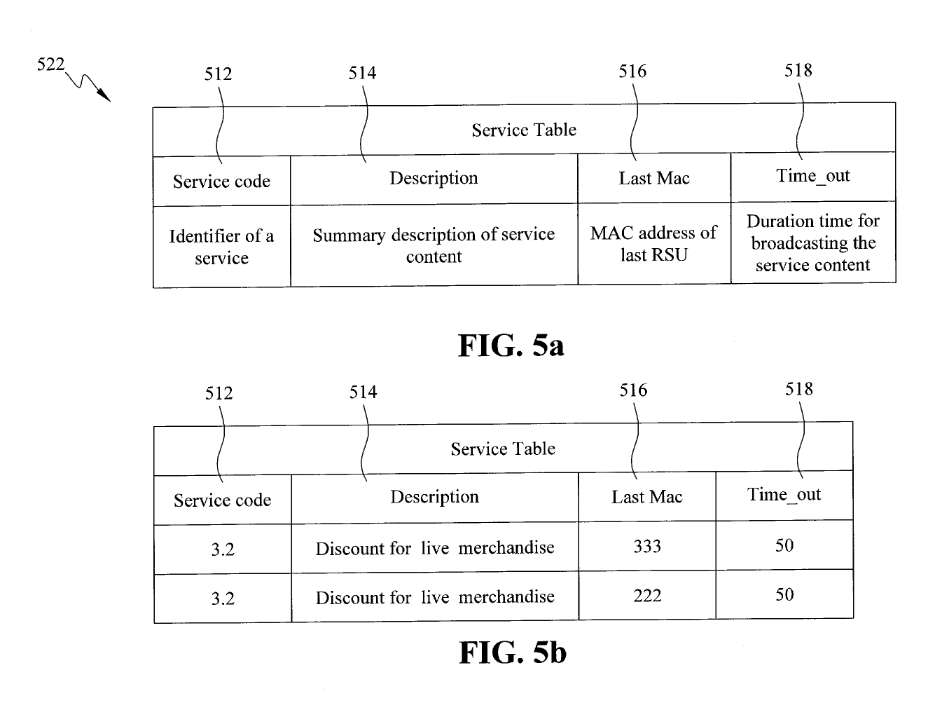

FIGS. 5a and 5b further describe service table 422, consistent with certain disclosed embodiments. FIG. 5a illustrates an exemplary field format of service table 422, and .FIG. 5b shows a working example of service table 522. As mentioned earlier, each agent i of RSU i may uses service table 422 to record the services currently performing service content broadcasting on the RSU i. Referring to FIG. 5a, each entry of the exemplary service table 522 at least includes 4 fields, i.e. service code 512, description 514, Last MAC 516 and time out 518. The service code field may record the identifier of a service, and content of the service may be identified based on the service code. The description field may record a summary description of the content for the service, such as, the geographic or traffic information surrounding the service. The Last Media Access Control (MAC) field may record a MAC address of a RSU requesting the deployment for the service. The time out field may record the duration of time for broadcasting the service content. The duration of time may be set by a mobile service provider when the mobile service provider applies for the service broadcasting. The 4-field information included in each entry of service table 422 will be transmitted from RSU i. to one of its neighboring RSUs. The details will be described later.

In the working example of FIG. 5b, for a service code 3.2 in the service table, there are two RSUs requesting the deployment for broadcasting the service content, such as real-time merchandise discount. One RSU has Last MAC address 333, and the other RSU has Last MAC address 222. In other words, different information of Last MAC address may be looked up in the service table by using service code as a key value.

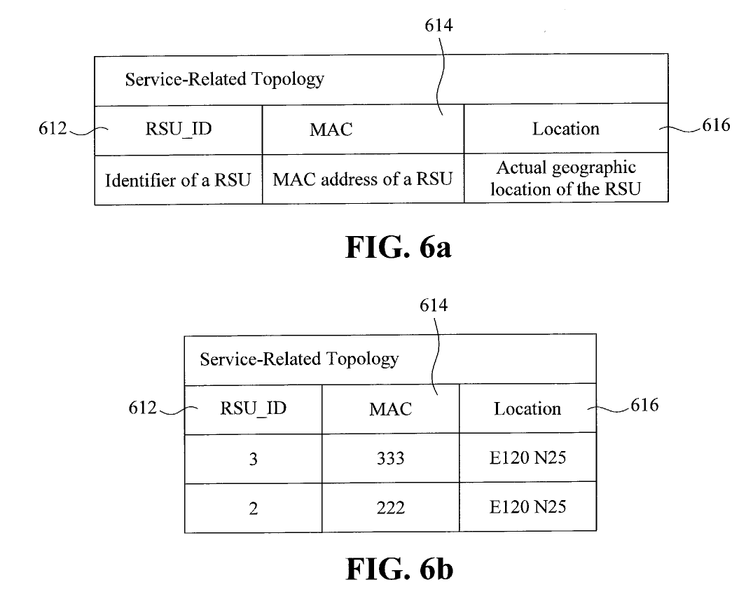

FIGS. 6a and 6b further describe service-related topology table 424, consistent with certain disclosed embodiments. FIG. 6a shows an exemplary field format illustrating service-related topology table 424, and .FIG. 6b shows an exemplary service-related topology table 424. As mentioned earlier, service-related topology table 424 may record the service-related RSUs when an agent performs the service broadcasting. Referring to FIG. 6a, each entry of service-related topology table 424 at least includes 3 fields, i.e. RSU_ID 612, MAC 614 and Location 616. The RSU_ID field may use a unique value as a RSU identifier. The MAC field may record the MAC address of RSU as the basis for identifying a source RSU and a target RSU when an agent performs service broadcasting. The Location field records an actual geographic location of the RSU. After the example of FIG. 5b has been deployed, the service-related RSUs may be obtained from service-related topology table 424. Accordingly, the information of neighboring RSUs, such as the working example of FIG. 6b, may be obtained. In other words, the actual geographic location of the neighboring RSUs for a source RSU may be obtained. Thereby, the agent in the source RSU may further broadcast the service request message to the agents in the neighboring RSUs, and .perform interactive regional service tracking.

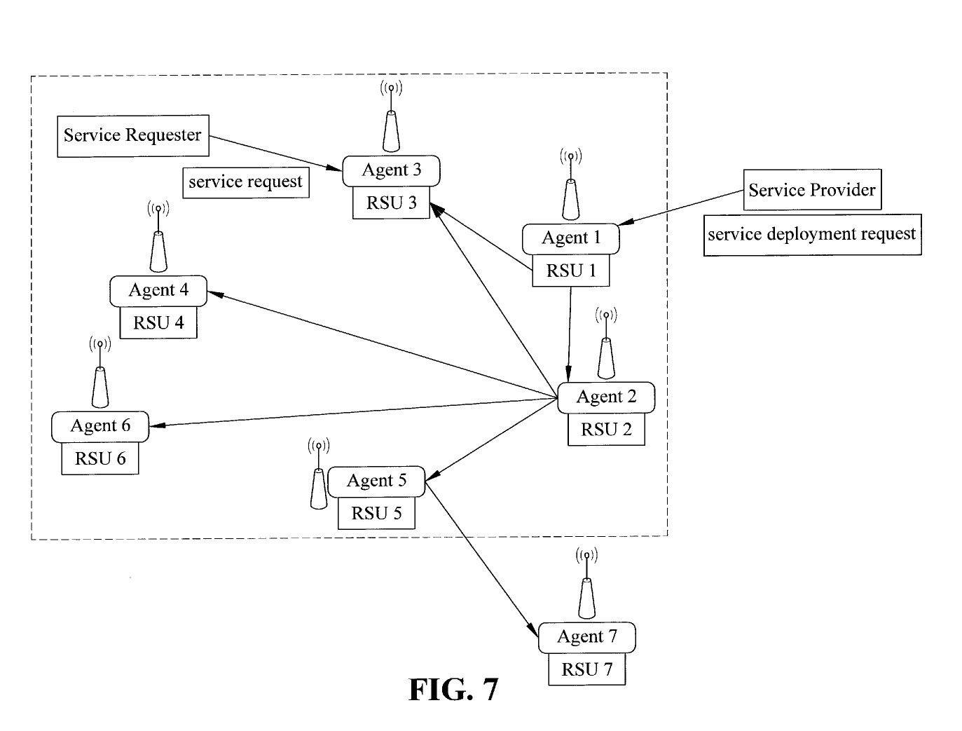

The service-related topology table may only record, for example, the first RSU in this RSU's neighborhood that can connect to this RSU through traffic. Take FIG. 7 as an example. The service-related topology table of RSU2 (source RSU) will only record the RSU_ID, MAC and Location fields of RSU3, RSU4, RSU5 and RSU6. The RSU_ID, MAC and Location fields of RSU7 will not be recorded by the service-related topology table of RSU2, because RSU7 is not the first RSU in the RSU2's deployment coverage 710 that can connect to RSU2 through traffic.

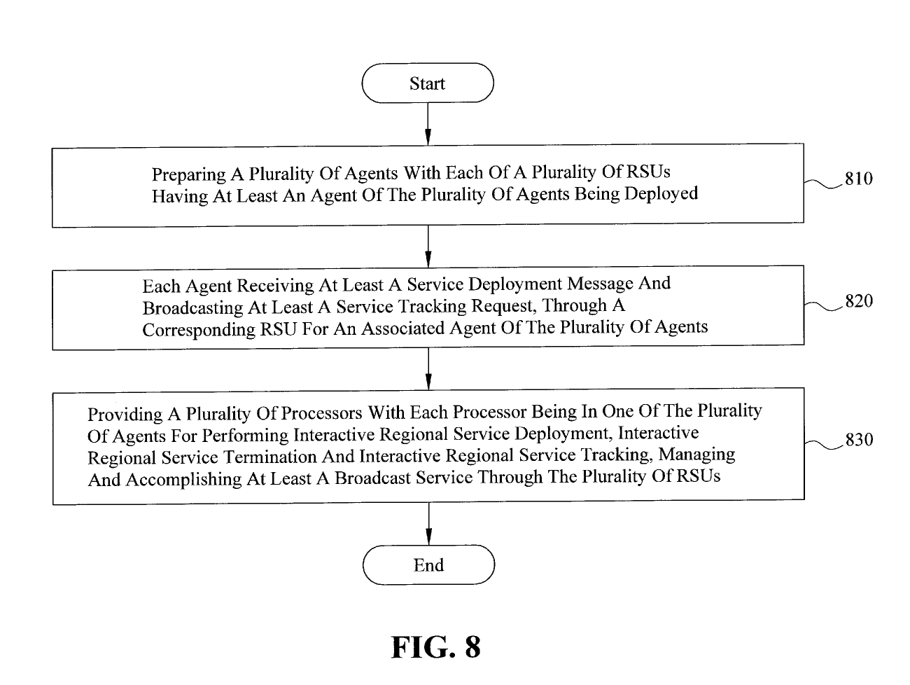

It may be noting that the traffic and geographic environment around RSU will not change multiple times during a short period of time, the contents of service-related topology are set manually or through other manners only when the RSU is initially deployed, or updated only when the traffic and geographic environment around the RSU changes. The following describes detailed operations of system 400 and processor 430. When proceeding interactive regional service broadcasting, two roles are distinguished in the exemplary embodiments of the present disclosure, i.e., the mobile service provider and the service requester. FIG. 8 shows an exemplary operation flow of a method for deployment and management of interactive regional broadcast services, consistent with certain disclosed embodiments.

Referring to FIG. 8, at first, the method may prepare a plurality of agents with each of a plurality of road side units (RSUs) having at least an agent of the plurality of agents being deployed, as shown in step 810. As shown in step 820, each agent may receive at least a service deployment message and broadcast at least a service tracking request, through its corresponding RSU, such as via a RSU receiving/transmitting device. The method may further provide a plurality of processors with each processor being in one of the plurality of agents for performing interactive regional service deployment, interactive regional service termination and interactive regional service tracking, managing and accomplishing at least a broadcast service through the plurality of RSUs, as shown in step 830. In FIG. 8, an agent of the plurality of agents may be implemented with such as a device, or an embedded system or a software module.

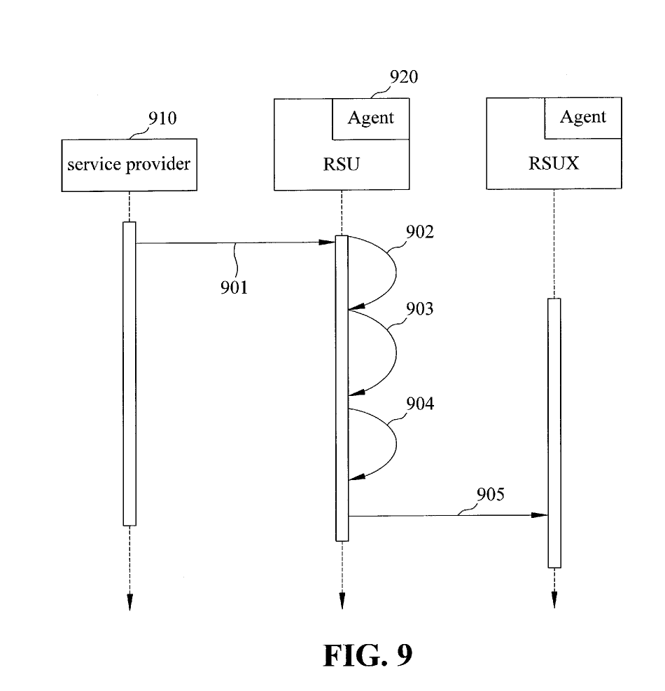

FIG. 9 shows an exemplary schematic view illustrating the interactive regional service deployment among a service provider, a corresponding RSU and its neighboring RSUs, consistent with certain disclosed embodiments. Referring to FIG. 9, after the corresponding RSU receiving a request for a service deployment (labeled as 901) from a service provider 910, a corresponding processor in an associated agent 920 for the corresponding RSU is further responsible for confirming whether a same service existing in the corresponding RSU (labeled as 902), confirming coverage of the requested service deployment (labeled as 903), confirming a time duration of the requested service deployment (labeled as 904), and extending the requested service deployment (labeled as 905) to its neighborhood, for example, some RSUX.

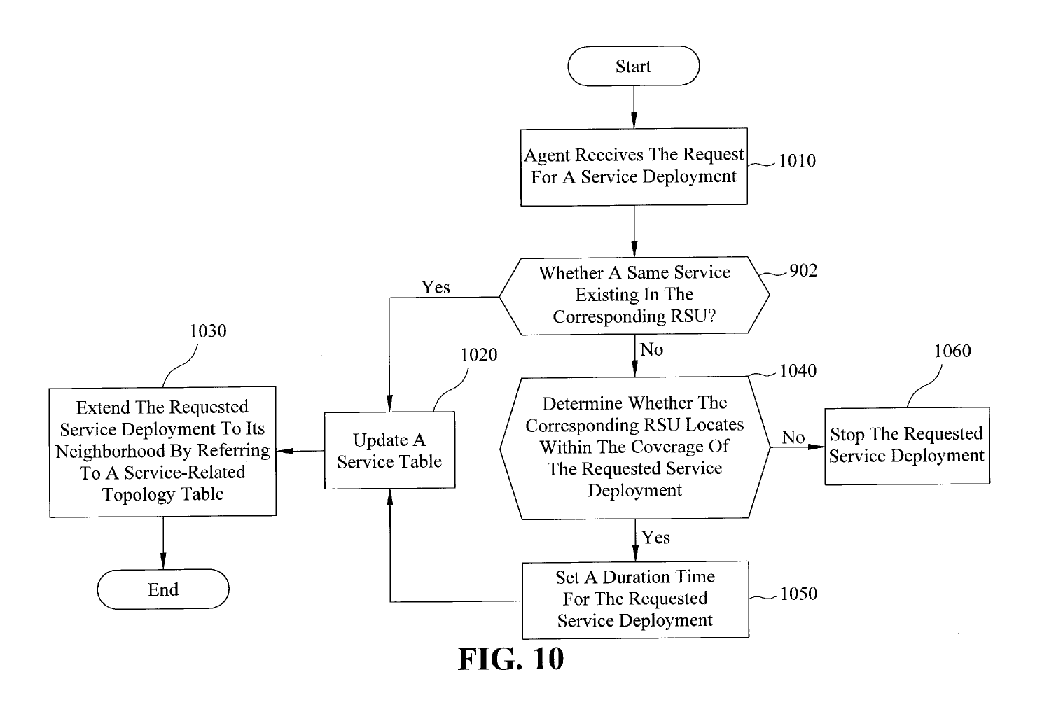

FIG. 10 shows an exemplary operation flow illustrating how an agent deployed in a corresponding RSU broadcasts the requested service deployment, consistent with certain disclosed embodiments. Referring to FIG. 10, the agent receives the request for a service deployment (step 1010). If a same service existing in the corresponding RSU, the agent updates a service table (step 1020) and extends the requested service deployment to its neighborhood by referring to a service-related topology table (step 1030). Otherwise, the agent determines whether the corresponding RSU locates within the coverage of the requested service deployment (step 1040). If yes, the agent sets a duration of time for the requested service deployment (step 1050) for updating the service table, i.e. step 1020; otherwise, the agent stops the requested service deployment (step 1060).

In step 1020, the agent will update the related information of the service content so that the agent can be informed that different RSUs deploy the same service content when inquiring the same service in the future. In step 1040, the range of the service deployment is set by the mobile service provider. In step 1050, the agent will set the time_out field according to the time limit set by the mobile service provider, and add information related to service content into the service table, such as service code, description, Last MAC and time_out fields.

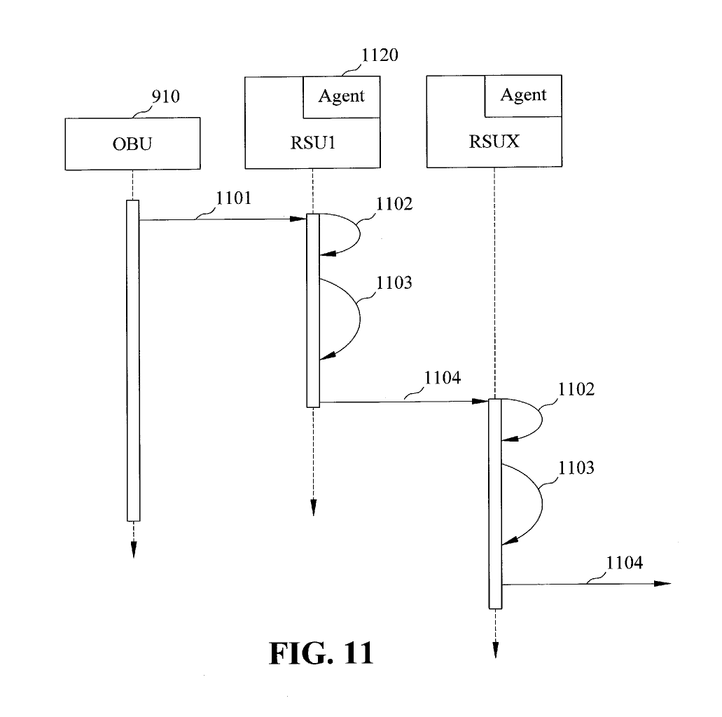

FIG. 11 shows an exemplary schematic view illustrating the interactive regional service termination among the service provider, the corresponding RSU and its neighboring RSUs, consistent with certain disclosed embodiments. Referring to FIG. 11, an OBU 1110 may send a request for a service termination to its corresponding agent 1120 (labeled as 1101). The processor in the agent 1120 receives the service termination request (labeled as 1102), verifies a service code carried in the service termination request (labeled as 1103), and forwards a service termination message (labeled as 1104) to its neighborhood, for example, some RSUX. So that the agents on the other RSUs, such as RSUX, may continue to finish the service termination request in a similar fashion.

A service provider may request to terminate a service on two conditions. One is the time limit for service broadcasting set by the service provider is expired. In the condition, the service termination is initiated through its corresponding RSU. The other is the service provider initiates service termination due to different reason.

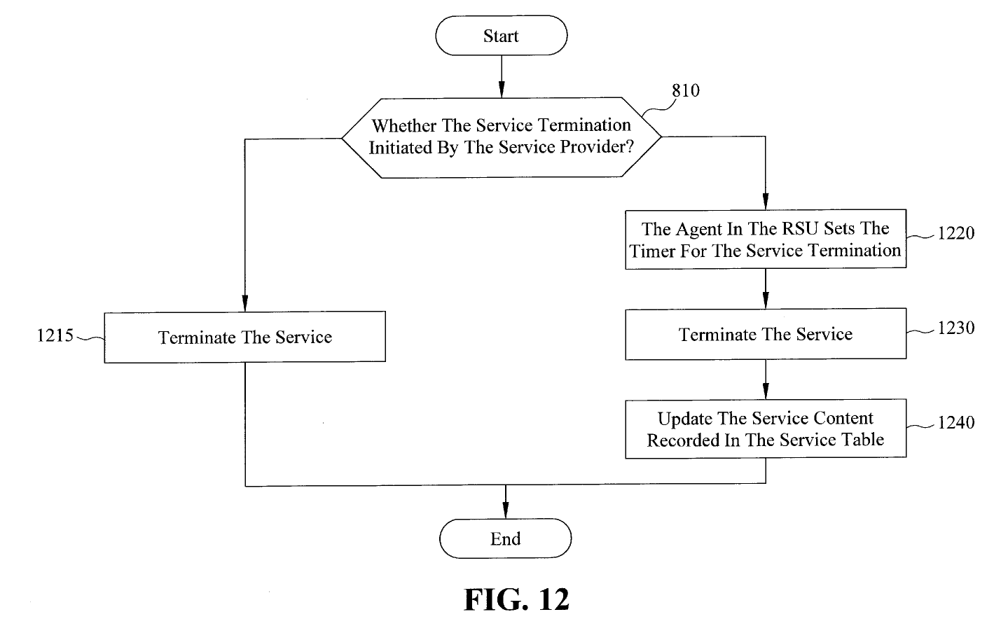

FIG. 12 shows an exemplary schematic view illustrating the service termination initiated through a service provider's corresponding RSU, consistent with certain disclosed embodiments. Referring to FIG. 12, at first, the agent checks whether the service termination initiated by the service provider (step 1210). If yes, the service provider initiates a service termination procedure (step 1215). Otherwise, the agent in the RSU sets the timer for the service termination (step 1220), terminates the service (step 1230), and updates the service content recorded in the service table (step 1240). In other words, the agent of RSU sets the service termination time for the service according to the value in the time_out field of the service table. When the service termination time is reached, the agent terminates the broadcast of the service content and removes the record of the service content from the service table.

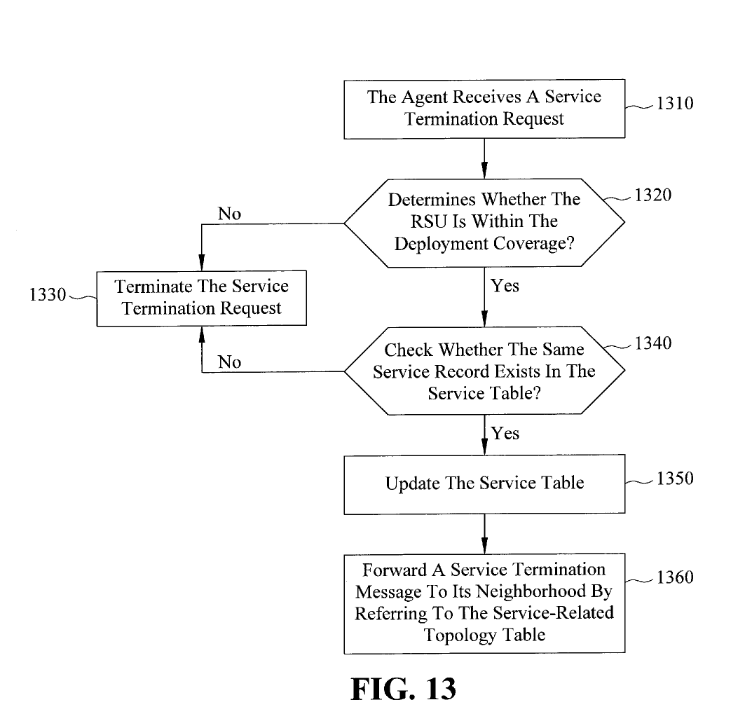

FIG. 13 shows an exemplary schematic view illustrating the service termination initiated by a service provider itself, consistent with certain disclosed embodiments. Referring to FIG. 13, the agent in the service provider's corresponding RSU receives a service termination request (step 1310) from the service provider. Then, the agent determines whether the RSU is within the deployment coverage (step 1320). This may be done by checking the coverage information carried in the service termination request. If not within the deployment coverage, the agent will terminate the service termination request (step 1330); otherwise, the agent will continue to check whether the same service record exists in the service table (step 1340). After confirming the same service content, the service table will be updated (step 1350). At the moment, the record of the service content in the service table will be removed. Finally, the agent will forward a service termination message to its neighborhood by referring to the service-related topology table (step 1360). From the service-related topology table, the neighboring RSU information may be obtained, so that the agents on the other RSUs can continue to finish the service termination request in a similar fashion.

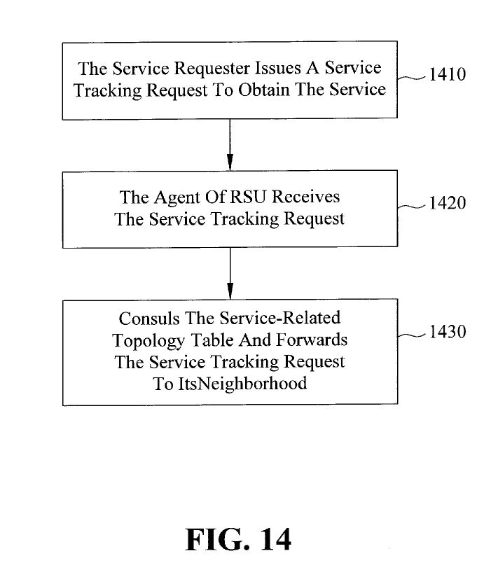

After a service requester obtains a service broadcast message within the coverage of a RSU, the service requester may issues a service tracking request to the RSU to obtain the service. FIG. 14 shows an exemplary schematic view illustrating the interactive regional service tracking, consistent with certain disclosed embodiments. Referring to FIG. 14, the service requester issues a service tracking request to obtain the service (step 1410). The agent of RSU receives the service tracking request (step 1420), consults the service-related topology table and forwards the service tracking request to its neighborhood (step 1430). In step 1430, the service-related topology table may provide information of neighboring RSUs. After the agents of other RSUs receive the service tracking request, the agents of other RSUs will follow the same mode to distribute the tracking request to other RSUs, and report the tracked information to the service provider.

The present disclosure also designs a fault-tolerance mechanism to avoid the problem that the agents cannot communicate during the process of tracking service provider because of the hardware/software, communication quality or environment factors. When the agents, such as the agents of other RSUs in the neighborhood of a RSU receives the service tracking request, are unable to communicate for a certain period of time, the agents will use the same service code to inquire the service table to find whether the same service content may be broadcasted by a different RSU. If the information of a different RSU exists, the service tracking request is sent to the different RSU to accomplish the service tracking.

In accordance with the exemplary embodiments of the present disclosure, a working example to assist a service provider to rapidly deploy the location-based service (LBS) may be proceeded as follows. Assume that a mobile pizza vendor tries to sell pizza close to Taipei Railway Station, and requests to a nearby RSU for service deployment for broadcasting a pizza promotional message. The deployment coverage of neighboring RSUs may include the RSUs around Taipei Railway Station. The time duration for broadcasting the pizza promotional message may be set to be two hours.

The process for interactive regional broadcast services may be described as follows. At first, the mobile pizza vendor may specify the parameters, i.e. the deployment coverage and the time duration for the broadcasting service, and requests to the nearest RSU around Taipei Railway Station for service deployment. Secondary, after the nearest RSU confirms the request sent by the mobile pizza vendor, the request is transmitted to a neighborhood, i.e. nearby RSUs, of the nearest RSU for confirmation on the parameters set by the mobile pizza vendor. The nearby RSUs will also repeat the same step until all the RSUs within the coverage specified by the mobile pizza vendor are all covered. When a service requester enters the deployment coverage and request to a nearby RSU, the nearby RSU will use the path established during deployment to communicate with the mobile pizza vendor. After two hours, all the RSUs in the neighborhood of the nearest RSU perform a service termination process to terminate the service.

Yet in an exemplary embodiment, a road side unit (RSU) in a system for deployment and management of interactive regional broadcast services may comprise at least an agent configured to receive at least a service deployment message transmitted by a service provider, broadcast at least a service tracking request transmitted by a service requester, and provide a processor for performing interactive regional service deployment, interactive regional service termination and interactive regional service tracking, managing and accomplishing at least a broadcast service. As mentioned above, an agent of the at least an agent may be implemented with such as a software module, or a device or an embedded system.

Although the present disclosure has been described with reference to the exemplary embodiments, it will be understood that the disclosure is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A system for deployment and management of interactive regional broadcast services, comprising a plurality of agents with each of a plurality of road side units (RSUs) having at least an agent of said plurality of agents being deployed, and each of said plurality of agents further including:
a RSU receiving/transmitting device for receiving at least a service deployment message and broadcasting at least a service tracking request;
a storage device for maintaining a service table recording information of at least a service currently performing broadcasting service content on a corresponding RSU, and a service-related topology table recording information of at least a RSU in a neighborhood of said corresponding RSU that can connect to said corresponding RSU, when an interactive regional service broadcasting is performed; and
a processor for performing interactive regional service deployment, interactive regional service termination and interactive regional service tracking, managing and accomplishing at least a broadcast service through said corresponding RSU and information recorded in said service table and said service-related topology table.

2. The system as claimed in claim 1, wherein each entry of said service table at least includes a service code field recording an identifier of a service currently performing broadcasting service content on said corresponding RSU, a description field recording a summary description of the service content of said service, a last media access control field recording a media access control address of a RSU requesting a deployment for said service, and a time out field recording a time duration for broadcasting the content of said service.

3. The system as claimed in claim 1, wherein each entry of said service-related topology table at least includes a RSU_ID field recording an identifier of a RSU of said at least a service-related RSU, a MAC field recording a MAC address of said RSU, and a location field recording an actual geographic location of said RSU, and said MAC field is used as a basis for identifying a source RSU and a target RSU when said agent performs a service broadcasting.

4. The system as claimed in claim 1, wherein said at least a service deployment message is a location-based service deployment message at least including information of a location range and a duration of time to be broadcasted for the location-based service, and said information is selected by a service provider.

5. The system as claimed in claim 1, wherein a service requester transmits said service tracking request to said corresponding RSU, and said service tracking request at least includes information of a service code and a service-related message.

6. The system as claimed in claim 1, wherein a service provider transmits said at least a service deployment message to said corresponding RSU.

7. The system as claimed in claim 2, wherein the 4-field information included in each entry of said service table is transmitted from said corresponding RSU to a neighboring RSU.

8. A method for deployment and management of interactive regional broadcast services, said method comprising:
preparing a plurality of agents with each of a plurality of road side units (RSUs) having at least an agent of the plurality of agents being deployed;
receiving at least a service deployment message transmitted by a service provider and broadcasting at least a service tracking request transmitted by a service requester, through a corresponding RSU for an associated agent of said plurality of agents; and
providing a plurality of processors with each processor being in one of said plurality of agents for performing interactive regional service deployment, interactive regional service termination and interactive regional service tracking, managing and accomplishing at least a broadcast service through said plurality of RSUs.

9. The method as claimed in claim 8, wherein after said corresponding RSU receiving a request for a service deployment from said service provider, a corresponding processor for said associated agent is responsible for confirming whether a same service existing in said corresponding RSU, confirming coverage of the requested service deployment, confirming a time duration of the requested service deployment, and extending the requested service deployment to a neighborhood of said corresponding RSU, for performing the interactive regional service deployment.

10. The method as claimed in claim 8, wherein after said corresponding RSU receiving a request for a service termination from said service provider, a corresponding processor for said associated agent receives said service termination request, verifies a service code carried in the service termination request, and forwards a service termination message to a neighborhood of said corresponding RSU, for performing the interactive regional service termination.

11. The method as claimed in claim 8, wherein after a service requester issues a service tracking request to said corresponding RSU to obtain a service, a corresponding processor for said associated agent receives the service tracking request, consults a service-related topology table and forwards said service tracking request to a neighborhood of said corresponding RSU, for performing the interactive regional service tracking.

12. The method as claimed in claim 8, wherein each of said plurality of agents follows and maintains a service table and a service-related topology table, said service table records at least a service currently performing service content broadcasting on said corresponding RSU, and said service-related topology table records information of at least a RSU in a neighborhood of said corresponding RSU that can connect to the RSU, when an interactive regional service broadcasting is performed.

13. The method as claimed in claim 8, wherein said at least a service deployment message at least including information of a location range and a duration of time to be broadcasted for a location-based service, and said information is selected by a service provider.

14. The method as claimed in claim 8, wherein said service tracking request at least includes information of a service code and a service-related message.

15. The method as claimed in claim 9, wherein said corresponding processor for said associated agent extends the requested service deployment to the neighborhood of said corresponding RSU by referring to information recorded in a service-related topology table.

16. The method as claimed in claim 10, wherein when the service termination initiated by said service provider, said corresponding processor for said associated agent terminates a service for the service termination and removes a record for the service from a service table, once a termination time for the service is reached.

17. The method as claimed in claim 11, wherein after the agents of other RSUs in said neighborhood receive said service tracking request, the agents of other RSUs also distribute said service tracking request to other RSUs, and report tracked information to said service provider.

18. The method as claimed in claim 17, wherein when the agents of other RSUs in said neighborhood are unable to communicate in a certain period of time, said corresponding processor for said associated agent inquires a service table to find a different RSU able to broadcast a same service content for the service, and sends said service tracking request to said different RSU to accomplish the service tracking when said different RSU exists.

19. The method as claimed in claim 8, wherein an agent of said plurality of agents is implemented with one of a software module, a device and an embedded system.

20. A road side unit (RSU) in a system for deployment and management of interactive regional broadcast services, comprising at least an agent configured to:
receive at least a service deployment message transmitted by a service provider and broadcast at least a service tracking request transmitted by a service requester; and
provide a processor for performing interactive regional service deployment, interactive regional service termination and interactive regional service tracking, managing and accomplishing at least a broadcast service.

21. The RSU as claimed in claim 20, wherein an agent of said at least an agent is implemented with one of a software module, a device and an embedded system.

22. The RSU as claimed in claim 20, wherein said at least a service deployment message is a location-based service deployment message at least including information of a location range and a duration of time to be broadcasted for the location-based service, and said information is selected by said service provider.
